(19) United States
(12) Patent Application Publication
(10) Pub. No.: US 2005/0044042 A1
(43) Pub. Date: Feb. 24, 2005

(54) Financial transaction system and method using electronic messaging

(76) Inventors: Dennis Mendiola, Philippines (SG); Roland Alen Rondolo Benzon, Philippines (SG); Anthony Albert Martinez Zamora, Philippines (SG)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/488,342

(22) PCT Filed: Aug. 1, 2002
(86) PCT No.: PCT/SG02/00172

(30) Foreign Application Priority Data
Aug. 31, 2001 (SG) 2001052687

(51) Int. Cl. G06F 17/60

(52) U.S. Cl. 705/42

(57) ABSTRACT

A method and a system for performing financial transactions between parties having clients (15a, 15b) with an electronic messaging facility and a banking account facility with a financial institution. Each party has an electronic messaging address (CIN) associated with the electronic messaging facility and a banking account number (CAN) associated with the banking account facility (27) thereof.

A financial service provider server (13) is interfaced with the electronic messaging facility to handle communications between the clients (15a, 15b) of the parties and is also interfaced with the banking account facilities (27) of the parties to perform the financial transaction. The electronic messaging address (CIN) of each party is linked with the banking account facility therefor, and thus the banking account number(s) (CAN) thereof, within a database (45) associated with the server (13) to facilitate the financial transaction.

The server (13) undertakes an authentication process within one and/or the other party using the electronic messaging facility requiring confirmation of a PIN also stored in the database (45). The authentication process is characterised by the server (13) providing the client (15a) of the one party instigating the financial transaction with a different electronic messaging address to “reply to” when requesting the PIN, from the original electronic messaging address of the server (13) used by that same party to initiate the financial transaction, to enhance the security of the transaction.

### FIELD OF THE INVENTION

This invention relates to a financial transaction system and a method of performing a financial transaction involving the use of electronic messaging such as SMS (Short Messaging System) messaging and email. The invention has particular, although not exclusive, application to the provision of person-to-person financial transactions using wireless devices, such as mobile phones, PDAs (personal digital assistants), pocket PCs (personal computers) and the like, where the person may be a consumer or merchant. The invention also finds application with the provision of financial transaction services using email and similar types of electronic messaging systems.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The undertaking of financial transactions between two parties using electronic messaging such as with wireless devices and email services has not been seriously pursued in the past due to security considerations, whereby the abiltiy of an unauthorised party to spoof the identity of another party without the knowledge of the other party is relatively straight forward to parties having some knowledge of the protocol followed in the communication exchange between a payor and a payee.

In recent times, with the added security features provided by mobile phones operating under the GSM (Global System for Mobile Communications) network, the area has been further developed and a number of different types of payment systems using wireless devices have come on to the market.

In one such payment system, facility is made for a user to call a prescribed telephone number of a financial service provider having a server set up to answer and process the telephone call. The user is intially prompted to enter a PIN (personal identification number) and is then advised to follow further prompts to make or request a payment instantly to or from another user/business/e-commerce business with a GSM phone number or a prescribed identification number of the financial service provider. When the user calls the financial service provider for the first time he/she is asked to record a personal greeting so that other users known to the user will easily identify him/her when making a payment between them. Accordingly, in a subsequent financial transaction occurring between the user and the other user using the system, the other user provides authentication of the user by way of sound recognition of the recorded greeting of the user, which is automatically played to the other user via their mobile phone on receiving a call from the server concerning the transaction, before the transaction is allowed to be undertaken.

Such an arrangement is relatively cumbersome and indeed is not practical to use when the parties are not familiar with each other. Furthermore, the implementation of such a system is more PC centric, involving the registration of users via a PC connected to the Internet, and thus is not able to be used with users having exclusive access to a wireless device and communicating soley by way of the instant messaging system provided therewith.

In the area of email communications, due to its close affiliation with the Internet and browser based applications for accessing the same, using email as a real time communication medium for performing financial transactions has never seriously been contemplated, given the superior real time characteristics of the Internet and the greater flexibility and power with operating security applications therein to avoid fraudulent and unathorised transactions from occurring. However, there are still a significant number of persons who are confined to, or indeed prefer to, use email as their principal communication medium in party-to-party communications. Thus, creating a financial transaction system and methodology that operates effectively with email would still have widespread consumer appeal, notwithstanding the popularity of the Internet and accessing the same with browser based devices.

### DISCLOSURE OF THE INVENTION

It is an object of the present invention to provide for an efficient and flexible system and method for performing financial transactions between parties using an electronic messaging system.

It is a preferred object of the present invention to provide for financial transactions using one or more wireless devices that provides for a high level of security.

In accordance with one aspect of the present invention, there is provided a method for performing financial transactions between two parties functioning as clients to a financial service provider server for controlling the transaction, the clients and server being interconnected via a communication network, at least one of the clients being a wireless device, and said financial service provider server being electronically connected to an account facility for each client, each account facility having a personal account for the client identified by an account number, and a wireless communication server for handling messages sent to or received from said wireless device using a wireless identifying number for the wireless device, the method comprising:—
ascribing a client identifying number to each of the clients of the financial service provider server to uniquely identify each client to the financial service provider server;
ascribing an access code to the financial service provider server to uniquely identify the financial service provider server to the wireless communication server and the nature of the transaction to be performed;
registering the account number of each client with the financial service provider server to enable the financial service provider to access the personal account of the client;
registering a personal identification number (PIN) for each client;
a sender client compiling and sending a text message to the financial service provider server in accordance with a first prescribed client protocol comprising:
   the amount to be transacted,
   the address of the other party to the transaction comprising: (i) the access code identifying the financial service provider server and the nature of the transaction, and (ii) the client identifying number of the other client, and
   the client identifying number of the client sending the message;
the financial service provider server on receipt of said text message compiling and sending back a further text message to the sender client in accordance with a first prescribed server protocol comprising:
   a confirmation of the transaction to be performed,
   a request for the PIN of the client, and
   a “reply to” address that is different to the previous address of the receiver;
the sender client on receipt of said further text message compiling and sending back another text message to the “reply to” address with a second prescribed client protocol comprising the PIN thereof;
the financial service provider server waiting a prescribed time for receipt of said other text message and if received within said prescribed time, verifying the PIN and if correct, compiling and sending an advisory text message to the other client in accordance with a second prescribed server protocol that includes an advice describing the transaction; and
on authenticating the transaction, the financial service provider server effecting the transaction between the account facilities of the parties to the transaction to which the financial service provider server is connected;
wherein if either said prescribed time elapses without receipt of said other text message or if the PIN is not verified to be correct by the financial service provider server, the transaction is abandoned by the financial service provider server.

Preferably, the method includes the financial service provider server generating the “reply to” address in accordance with the first prescribed server protocol to include the access code and a pseudo-randomly generated number.

Preferably, the method includes the financial service provider server generating a prescribed “reply to” address comprising the access code of the financial service provider server to be included in the second prescribed server protocol.

Preferably, the second prescribed server protocol includes: the financial service provider server also including a request for the PIN of the other client in the advisory text message and making the prescribed “reply to” address different from any previous address identifying the financial service provider server; and

the method includes:

the other client compiling and sending back a reply text message to the prescribed “reply to” address with the PIN thereof on receipt of the advisory text message; and
the financial service provider server waiting a prescribed time for receipt of said reply text message and if received within said prescribed time, verifying the PIN and if correct, authenticating the transaction.

Preferably, the method includes generating the prescribed “reply to” address so that it includes the access code and a pseudo-randomly generated number.

In accordance with another aspect of the present invention, there is provided a system for performing financial transactions between two parties comprising:—
a financial service provider server for controlling a financial transaction between the parties;
each party having:
   (i) an account facility that includes a personal account for the party identified by an account number registered with said financial service provider server,
   (ii) a client for connection to said financial service provider server via a communication network, whereby at least one of the clients is a wireless device,
   (iii) a client identifying number to uniquely identify each client to the financial service provider server, whereby the client identifying number for the client that is a wireless device corresponds to the wireless identifying number thereof, and
   (iv) a PIN registered with said financial service provider server;
said financial service provider server being electronically connected to:
   (i) each account facility and being able to identify and access same by said account number on registration of same with said financial service provider server, and
   (ii) a wireless communication server for handling messages sent to or received from said wireless device using a wireless Identifying number for the wireless device;
a said client having messaging means for compiling and sending text messages to said financial service provider server in accordance with:
   (i) a first prescribed client protocol comprising:
      the amount to be transacted,
      the address of the other party to the transaction comprising: an access code to uniquely identify the financial service provider to the wireless communication server and the nature of the transaction to be performed, and (ii) the client Identifying number of the other client, and
      the client identifying number of the client sending the message; and
   (ii) a second prescribed client protocol comprising the PIN thereof; and
the financial service provider server having message handling means, authenticating means, transacting means and transaction abandoning means;
   wherein:
(a) said message handling means is designed to:
   (i) receive a said text message and compile and send back a further text message to the sender client in reply thereto in accordance with a first prescribed server protocol therefor comprising:
      a confirmation of the transaction to be performed,
      a request for the PIN of the client, and
      a “reply to” address that is different to the previous address of the receiver; and
   (ii) wait a prescribed time for receipt of another text message from the sender client in accordance with a second prescribed client protocol comprising the PIN of the sender client, and if said other text message is received within said prescribed time, verify the PIN and if correct, compile and send an advisory text message to the other client in accordance with a second prescribed server protocol comprising an advice describing the transaction;
   (b) said authenticating means is designed to authenticate the transaction on said message handling means establishing a prescribed level of security of the identity of the parties to the transaction;
   (c) said transacting means effecting a transaction in accordance with said text message between the parties in response to said authenticating means authenticating said transaction; and
   (d) said transaction abandoning means abandoning said transaction if either said prescribed time elapses without receipt of said other text message or if the PIN is not verified to be correct by the message handling means.

Preferably, the message handling means includes a pseudo-random number generating means to pseudo-randomly generate a number, and said message handling means generates the “reply to” address in accordance with the first prescribed server protocol for said further text message, so as to comprise the access code and the pseudo-randomly generated number.

Preferably, the message handling means generates a prescribed “reply to” address in accordance with the second prescribed server protocol for said advisory text message, comprising the access code of the financial service provider.

Preferably, the advisory text message compiled in accordance with said second prescribed server protocol includes a request for the PIN of the other client and a prescribed “reply to” address that is different from any previous address identifying the financial service provider server.

Preferably, said message handling means is also designed to wait a further prescribed time for receipt of a reply text message from the other client in accordance with a first prescribed client protocol for the other client comprising the PIN of the other client, and if received within said further prescribed time period, verify the PIN.

Preferably, the prescribed “reply to” address Is generated so that it includes the access code and a further pseudo-randomly generated number from said pseudo-random number generating means.

Preferably, said authenticating means authenticates the transaction if said message handling means verifies that the PIN of the other client received in said reply text message is correct.

In accordance with a further aspect of the invention, there is provided a method for performing a financial transaction for a party having an electronic messaging facility, the party having an electronic messaging address and a banking account number for a banking account with a financial institution, whereby a financial transaction may be performed with the banking account, and the financial institution having a banking server for effecting a financial transaction with the banking account, the method comprising:—
serving an electronic message from a client of the party, the electronic message:
   (i) being sent to a predetermined electronic messaging address for performing a particular type of financial transaction;
   (ii) being prepared in accordance with a first prescribed protocol; and
   (iii) requesting that the particular type of financial transaction be performed; and
requesting the banking server of the financial institution of the party to effect the financial transaction in accordance with the first prescribed protocol of the electronic message.

Preferably, the server includes serving an electronic message to the client of the party in response to serving said electronic message from the client of the party for controlling the progress of the financial transaction.

Preferably, the method includes linking the electronic messaging address to the banking account of the party.

Preferably, the serving includes authenticating the identity of the party before proceeding with requesting the banking server to effect the transaction,

Preferably, the authenticating includes requesting a personal identification number (PIN) to be provided by the party in a further electronic message prepared in accordance with a second prescribed protocol, and verifying that the PIN provided in the further electronic message is correct.

Preferably, the authenticating includes timing out a prescribed time period after requesting the PIN from the party and abandoning the financial transaction if the further electronic message is not provided by the party within said prescribed time period.

Preferably, the authenticating includes supplying a different electronic messaging address to the party from the predetermined electronic messaging address, for the party to reply to in order to progress the financial transaction.

Preferably, the method includes pseudo-randomly generating part of the different electronic messaging address to ensure that it is different and not derivable from the predetermined electronic messaging address.

Preferably, the particular type of financial transaction involves a financial transaction between two said parties each having electronic messaging facilities, whereby:
(i) the electronic message is served from a client of one party and includes requesting that the particular type of financial transaction be performed with the other party; and
(ii) the banking server of the financial institution of each party is requested to effect the financial transaction relative to the particular party in accordance with the first prescribed protocol of the electronic message.

Preferably, the electronic message includes the electronic messaging address of the one party and either the electronic messaging address or the banking account number of the other party.

In accordance with yet a further aspect of the invention, there is provided a system for performing a financial transaction for a party having an electronic messaging facility, the party having an electronic messaging address and a banking account number for a banking account with a financial institution, whereby a financial transaction may be performed with the banking account, and the financial institution having a banking server for effecting a financial transaction with the banking account, the system comprising:—
a financial service provider server having message handling means for serving an electronic message from a client of the party, the electronic message being prepared in accordance with a first prescribed protocol and including:
(i) a predetermined electronic messaging address dedicated to the performance of a particular type of financial transaction; and
(ii) a request that the particular type of financial transaction be performed;
wherein the financial service provider server includes message handling means to receive and decode said electronic message, and transacting means to request the banking server of the financial institution of the party to effect the financial transaction in accordance with the first prescribed protocol of the electronic message on the financial service provider server receiving said electronic message.

Preferably, the message handling means is adapted to serve an electronic message to the client of the party in response to serving said electronic message from the client of the party for progressing the financial transaction.

Preferably, the financial service provider server includes a database that links said electronic messaging address to the banking account of the party.

Preferably, the financial service provider server includes authenticating means to authenticate the identity of the party before invoking said transacting means.

Preferably, the message handling means is adapted to request a PIN from the party in a further electronic message prepared in accordance with a second prescribed protocol, and the authenticating means includes verifying means to verify that the PIN provided in the further electronic message is correct.

Preferably, the authenticating means includes timing means to time out a prescribed time period after requesting the PIN from the party and said financial service provider server includes abandoning means to abandon the financial transaction if said further electronic message is not provided by the party within said prescribed time period.

Preferably, the authenticating means includes supplying a different electronic messaging address to the party from the predetermined electronic messaging address for the party to reply to in order to progress the financial transaction.

Preferably, the message handling means includes a pseudo-random number generating means to pseudo-randomly generate part of the different electronic messaging address to ensure that it is different and not derivable from the predetermined electronic messaging address.

Preferably, the particular type of financial transaction involves a financial transaction between two said parties each having electronic messaging facilities, whereby:
(i) said electronic message is served by said financial service provider server from a client of one party at an electronic messaging address dedicated to the performance of a financial transaction between the two parties and includes a request that the particular type of financial transaction be performed with the other party; and
(ii) the banking server of the financial institution of each party is requested by said financial service provider server to effect the particular financial transaction relative to the particular party in accordance with the first prescribed protocol of said electronic message.

Preferably, the electronic message includes the electronic messaging address of the one party and either the electronic messaging address or the banking account number of the other party.

### BRIEF DESCRIPTION OF THE DRAWINGS

The invention will now be described by way of one specific embodiment. The description is made with reference to the accompanying drawings, wherein:

FIG. 1 is a schematic block diagram showing the general arrangement of the components of the financial transaction system;

FIG. 2 is a block diagram showing the basic configuration of the clients of the parties and the financial service provider server to enable a financial transaction to be performed;

FIG. 3 is a schematic block diagram showing the basic make up of a communication packet sent between a client and the server, and vice versa;

FIGS. 4A to 4F show the changes in the communication packet content according to the different protocols followed in an example of a financial transaction undertaken by the system, wherein:

FIG. 4A shows the packet for the text message in accordance with the first protocol sent by Client A to the server;

FIG. 4B shows the packet for the further text message in accordance with the first protocol sent by the server back to Client A;

FIG. 4C shows the packet for the other text message in accordance with the second protocol sent by Client A back to the server;

FIG. 4D shows the packet for the advisory text message in accordance with the second-protocol sent by the server to Client B;

FIG. 4E shows the packet for the reply text message in accordance with the first protocol sent by Client B to the server; and

FIG. 4F shows the packet for the confirmation text message in accordance with the third protocol sent by the server to Client A and by the server to Client B;

FIGS. 5A and 5B are flow charts showing the process followed in performing an authenticated financial transaction; and

FIG. 6 is a flow chart showing the process followed In registering an account number with the financial service provider server and linking it with the client identifying number.

### BEST MODE(S) FOR CARRYING OUT THE INVENTION

The embodiment is directed towards an electronic system comprising a client server computer system for performing financial transactions between a plurality of parties using electronic messaging and a method therefor. In the present embodiment, the parties each have a wireless device that constitutes a client of the system and each have account facililties with one or more banks or similar financial institution. Accordingly, financial transactions are performed utilising electronic messaging in the form of SMS text messages.

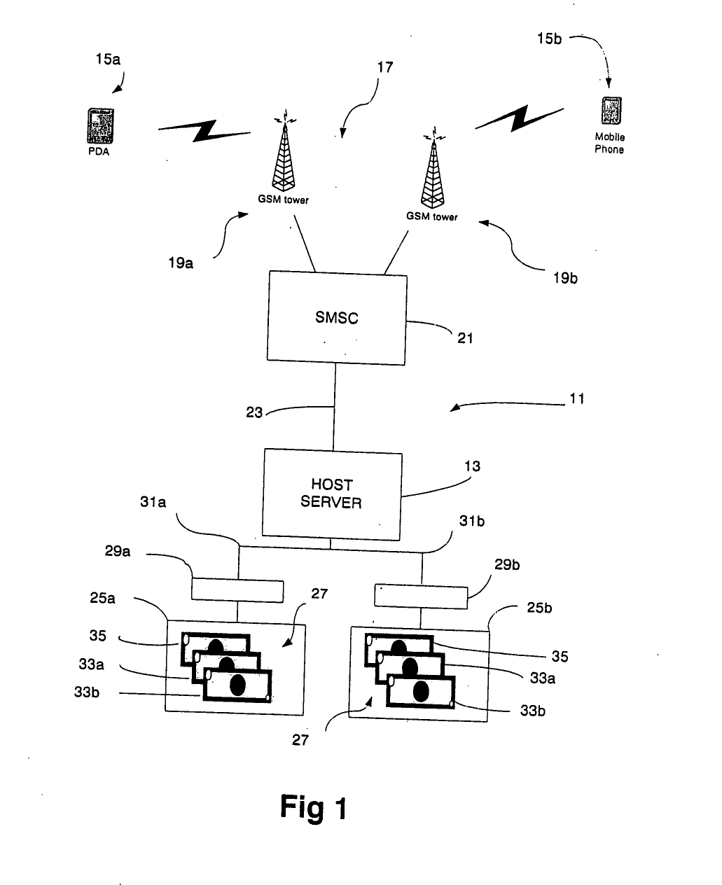

As shown in FIG. 1 of the drawings, the system 11 generally comprises:
a financial service provider server, which functions as a host server 13;
a plurality of clients 15, one client 15a being in the form of a PDA, and another client 15b being in the form of a mobile telephone, which clients 15a and 15b are respectively associated with parties A and B to a financial transaction;
a GSM mobile telephone network 17 having Instant messaging facilities of the SMS type, the network including GSM towers 19a and 19b to which the clients 15a and 15b are in communication range for effecting the financial transaction;
an SMSC (SMS Centre) server 21 forming part of the GSM network 17 for controlling and managing the SMS communications within the GSM network;
a communication link 23 interconnecting the host server 13 and the SMSC server 21 for allowing communications therebetween so that the GSM network in conjunction with the host server form a larger communication network;
account facilities 25 for each party are housed In a particular bank of the party, one bank housing the facility 25a for party A, and another bank housing the facility 25b for party B, each facility comprising one or more different account types 27, which are accessible via banking servers 29a and 29b respectively associated with the banks; and
further communication links 31 between the host server 13 and the banking servers 29, the further link 31a specifically connecting the host server to the banking server 29a associated with the bank of party A, and the further link 31b connecting the host server to the banking server 29b associated with the bank of party B.

The operation of GSM networks using SMS messaging and the transferring of instant messages between mobile clients and a host server via an SMSC of the type being the subject of the present embodiment has been described in International patent applications PCT/SG00/00068, PCT/SG00/00069, PCT/SG00/00070, PCT/SG00/00092, PCT/SG00/00127 and Singapore Patent Application 200007381-7 of which the applicant is a licensee. Accordingly, the disclosures contained in these applications are incorporated herein by reference.

A salient feature of each of the wireless clients disclosed in the aforementioned applications and which is also adopted in the present embodiment is the use of the network identifying number, for uniquely identifying the wireless client to the wireless communication network—in this case the GSM telephone number of the client in the GSM mobile telephone network 17—as the client identifying number (CIN) used by the host server 13 for identifying the client within its own database.

As also indicated in the aforementioned applications, the communication link 23 between the host server 13 and the SMSC server 21 may be a dedicated channel, such as a leased line, or a general-purpose channel, such as via the Internet.

With respect to the account facilities 25 associated with each client, in the present embodiment, the account types 27 comprise one or more personal accounts 33, such as a debit-credit savings account 33a and a debit-credit current or cash account 33b, and a host account 35 belong to the financial service provider that hosts the host server 13. The host account 35 is common to all of the parties that are customers of a particular bank, whereby each bank having a customer that is a party associated with a client of the system, also has a common host account. The reason for this will become apparent later.

The personal accounts 33 of a party associated with each client 15 are identified by a client account number (CAN), which needs to be registered with the host server 13. Accordingly, the host server 13 uses the CAN to access the personal accounts 33 of a party when communicating with a corresponding banking server 29, via the appropriate further link 31.

In order to authenticate a client of a party desiring to access an account facility with the bank, it is customary for the party to have a PIN, which is secretly recorded with the bank, and supply this PIN together with the name of the party and the CAN, before access to the account will be allowed. In the present embodiment, a similar authentication procedure with clients of parties is also required by the host server 13 before it Is able to access the account facility in response to a request by a client of a party in order to effect a financial transaction. Accordingly, each client of the host server is required to have a PIN registered by way of the client with the host server. In a similar manner to the bank, the host uses the PIN to correctly authenticate a client wishing to perform a transaction, before the transaction is allowed to be undertaken.

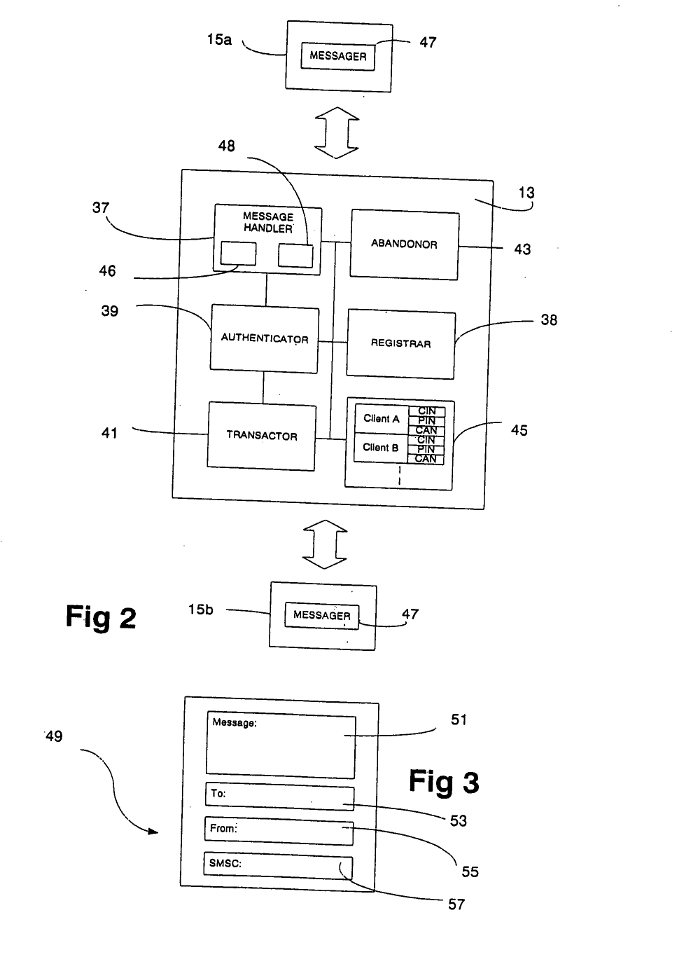

In order to provide for financial transactions between two clients, the host server 13 is specially configured to incorporate various processes for registering the clients and performing the transaction. As shown in FIG. 2 of the drawings, these processes include a message handling means or message handler 37, a registering means or registrar 38, an authenticating means or authenticator 39, a transacting means or transactor 41 and a transaction abandoning means or abandonor 43. These processes variously communicate with a client database 45 that lists the CIN, PIN and CAN against each party having a client registered on the database so that the host server may perform a financial transaction therefor. The client database 45 Is a relational database, which allows for the account facilities of the party to be selected, either by nominating the GSM mobile telephone number of the party, or alternatively the CAN or a personal banking account number of the party if this Is known.

The message handler 37 is programmed to receive text messages from clients of the host server 13 in accordance with prescribed client protocols, compile and send text messages to particular clients In accordance with prescribed server protocols, and interact with the authenticator 39 and client database 45 to veryify the identity of the parties to a particular transaction, all according to a prescribed message handler control algorithm. The message handler 37 is also programmed to interact with the registrar 38 to effect registration of parties having clients wishing to utilise the services provided by the host server 13 of the financial service provider to perform financial transactions between various parties.

The message handler 37 also includes a pseudo-random number generating means or pseudo-random number generator 46 for randomly generating a “reply to” address in accordance with a prescribed protocol. The randomly generated “reply to” address is then used by the message handler as the “reply to” address for the host server 13 in the compiling of text messages sent to clients in accordance with the prescribed server protocol.

The message handler 37 also includes a timing means or timer 48 to count down a prescribed time period. The message handler is programmed to Invoke the timer 48 and wait for receipt of reply text messages from clients within this prescribed time period and verify PINs for specific clients provided therein.

The authenticator 39 is programmed to authenticate a particular transaction being undertaken at a particular point in time after the message handler 37 has verified the identity of the parties to the transaction to a prescribed level of security, in accordance with a prescribed authentication control algorithm. Thus the authenticator 39 functions in conjunction with the message handler 37 to determine when a particular transaction between two parties has been authenticated sufficiently to be transacted.

The transactor 41 is programmed to actually effect a transaction between the parties using the account facilities 25 established at the respective banks of the parties, in accordance with a prescribed transaction control algorithm. The transactor 41 is not invoked until the authenticator 39 has authenticated the transaction. On the transaction being authenticated, the transactor 41 communicates with the relevant bank server(s) 29 to effect internal transactions between the personal accounts 33 of the parties and the common host account 35 at the relevant bank(s) using the CAN of the appropriate parties and the CAN of the host account to complete the transaction.

The abandonor 43 is programmed to abandon the operation of the host server 13 in attending to a transaction being undertaken in accordance with a prescribed transaction abandoning control algorithm. The abandonor 43 operates in conjunction with the message handler 37 to determine if the prescribed time period counted down by the timer 48 elapses without a requisite response being received by either party at the requisite address during the authentication process, after a party has been prompted to provide such a response. It also operates in conjunction with the message handler 37 to determine whether a PIN supplied by a party is verfied by the message handler to be correct. If either the prescribed time period elapses or a PIN is not verified the abandonor 43 abandons the transaction by instructing the message handler 37 to send appropriate text messages to the relevant parties notifying them of the abandonment of the transaction and terminating further operation of the transaction process being undertaken by the message handler.

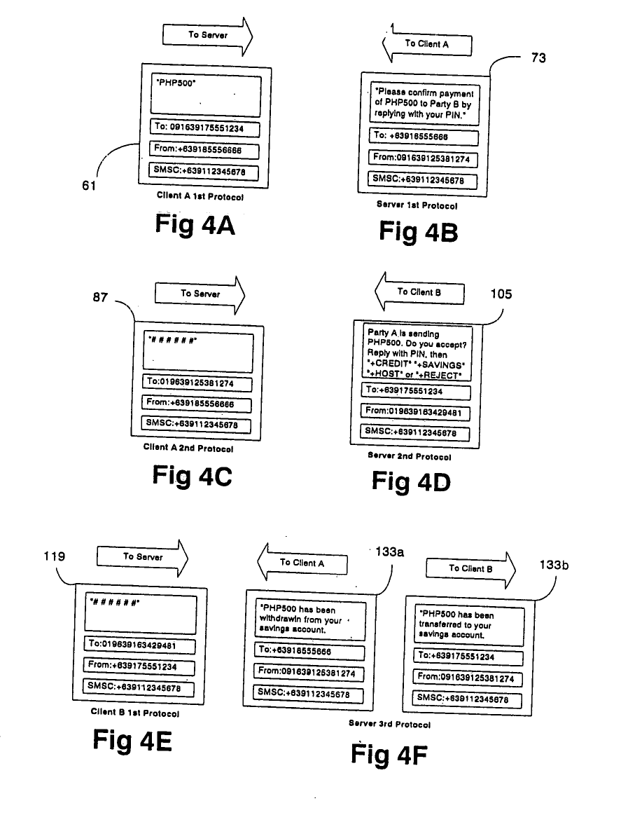

The client 15, on the other hand, is configured to incorporate a messaging means or messager 47. The messager 47 is a standard text messager for compiling and sending an SMS message packet 49 to an intended recipient as shown in FIG. 3 of the drawings that is transmitted to and handled by the SMSC server 21 for delivery to the recipient.

As described in the co-pending applications of the applicant, the message packet 49 includes a message portion 51, an intended recipient address portion 53, a sender's address portion 55 and an SMSC server address portion 57.

In the case of performing a financial transaction between two parties using the services of the financial service provider, the message packet 49 needs to be compiled by a client using the messager 47 according to different prescribed client protocols in order to communicate with the host server 13. Similarly, the message handier 37 also needs to be able to compile message packets in accordance with different prescribed server protocols to communicate with the clients 15 of the parties.

As the communication network involves communications between the SMSC server 21 and the host server 13, an access code is used in text messages sent by a client to the host server to signify to the SMSC server that the message needs to be sent to the host server for receipt and actioning, as opposed to being sent as an SMS message directly to a client of the GSM telephone network, without the involvement of the host server.

This access code performs a dual function in that, in addtion to signifying that the text message needs to be sent to the host server 13, it also indicates to the host server 13, the nature of the transaction being performed. In the case of the present embodiment, it signifies that not only a financial transaction is desired to be performed, but also the nature of the transaction, for example whether the transaction is an account balance query, or a payment to be made from the instigating party to an intended recipient party using the clients thereof, or a payment to be made to the instigating party from an intended recipient party. Thus different access codes recorded with the SMSC server 21 are used to signify different types of transactions to be performed.

As described in the applicant's co-pending applications, the power of such an arrangement allows a party of a client 15a compiling a text message for the purposes of undertaking a financial transaction to simply enter:
the access code pertaining to the nature of the transaction desired to be performed and the GSM telephone number of the other party to the transaction, if the transaction is to be a party-to-party transaction as the intended recipient's address 53; and
the amount of the transaction, if the transaction is to be a party-to-party transaction, in the message portion 51.

Once the text message is compiled, it then simply needs to be sent, and thereafter the transaction proceeds under the control of the host server 13.

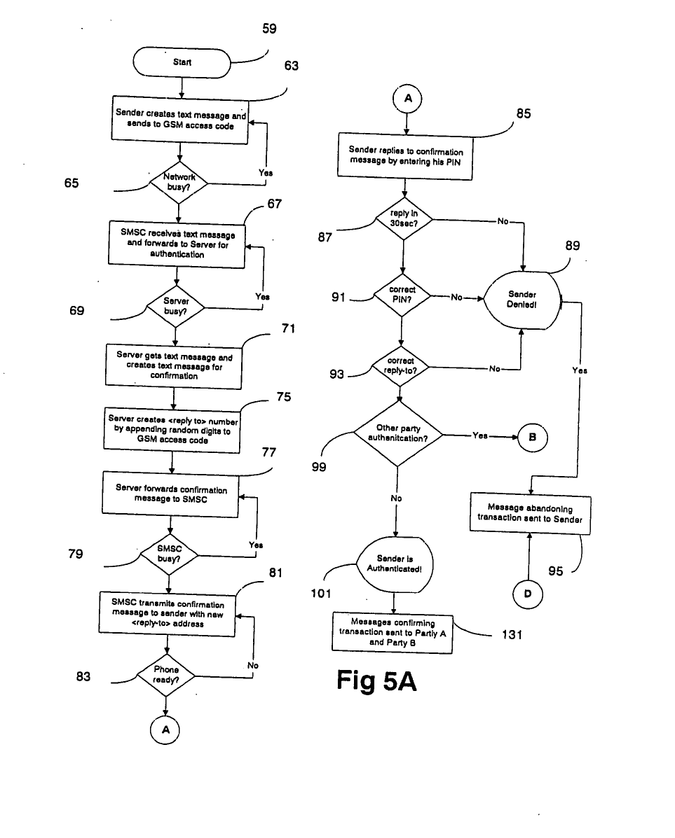

Thus a financial transaction is undertaken by the clients 15 and the host server 13 sequentially following alternate prescribed protocols, whereby resultant message packets 59 are sent from a client to the host server 15, then from the host server to a client, and so on, until the financial transaction is completed, as shown in FIGS. 4A to 4F.

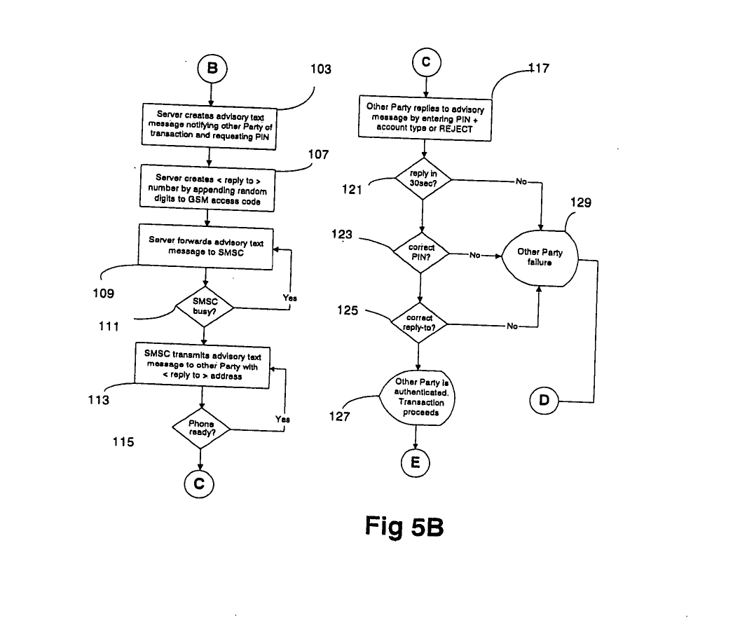

Now describing the precise process followed In performing a financial transaction, reference is made to FIGS. 4A to 4F and FIGS. 5A and 5B, and a specific example of a party-to-party transaction between Party A and Party B.

The transaction commences at step 59 with Party A compiling a text message with client 15a (Client A) in accordance with a first prescribed client protocol and sending it as an SMS message represented by the message packet 61 in FIG. 4A to the host server 13. This entire process is represented by the step 63 shown in FIG. 5A.

In the particular example shown, a payment is made from Party A to Party B, whereby Party A enters the text “PHP500” into the message portion 51 to represent that an amount of 500 Philippine Pesos is to be transacted. Party A enters the access code “091” followed by the GSM telephone number “639175551234” of Party B for the intended recipient's address, which will be located in the address portion 53 of the message packet. The particular access code is that provided for making a withdrawal of an amount from one of Party A's personal accounts 33 and depositing this amount into one of Party B's personal accounts 33.

On sending the message, the messager 47 of Client A automatically enters the sender's GSM telephone number into the sender's address portion 55 of the message packet 61, which in the present example is “+639185556666”, and the GSM telephone number of the SMSC server 21 in the SMSC server address portion 57, which in the present example is “+639112345678”.

If the telecommunication network is busy and the SMS message cannot be received by the SMSC server 21, the sender is notified of same and is required to send the message again, as indicated by step 65.

If the telecommunication network is not busy, the SMS message packet 61 is then received by the SMSC server 21, which upon recognising the access code, immediately sends the message packet to the host server 13 via the communication link 23, as shown in step 67. If the host server 13 is busy, then the SMSC server 21 is notified of this and continues to poll the host server until it is not busy, as represented by step 69.

On the host server 13 receiving this message packet, the message handler 37 thereof processes Its contents logically, and on decoding same, compiles a further text message to the sender client In accordance with a first prescribed server protocol, as shown at step 71. This further text message is sent in the form of a reply SMS message packet 73 back to Client A, as shown in FIG. 4B.

The first server protocol involves the message handler 37 entering:
a confirmation of the request to go in the message portion 51 of the message packet 73,
a request for the PIN of Client A also to go in the message portion 51, and
a “reply to” address that is different to the previous address of the host server to which the sender client A sent the originating text message to go in the sender's address portion 55 of the message packet.

In the present example, the confirmation and request for PIN message that is entered reads “Please confirm your payment of PHP500 to Party B by replying with your PIN”.

The “reply to” address is created in conjunction with the use of the pseudo-random number generator 46 and comprises the access code plus a pseudo-random number of a prescribed number of digits. In the present example, the access code is “091” and the pseudo-random number is the eight digit number “25381274”. Thus the message handler 37 uses the pseudo-random number generator 46 to generate a pseudo-random number and enters the access number followed by the eight digit pseudo-random number into the sender's address portion 55 as shown at step 75.

A pseudo-random number can be used in this manner, as the host server 13 has already been provided with the CIN of Party B in the originating SMS message packet 61 (by virtue of the GSM telephone number of Party B that is appended to the access code). Thus, as the SMSC server 21 is only concerned with decoding the access code for the purposes of directing SMS message packets sent by clients intended for the host server 13 (in the present example the access code constituting only the first three digits of the Intended receiver's address), the remaining portion of the intended receiver's address following the access code is effectively redundant. The present arrangement takes advantage of this redundancy to improve the security of the transaction by appending a pseudo-random number to the access code and thus creating a “reply to” address for the further text message that will be different for each transaction and which is not discernable from the original address of the host server.

On completing the compilation of the further text message, the message handler 37 sends it as the SMS message packet 73 to the SMSC server 21 along the communication link 23 for subsequent transmission by the SMSC server to Client A, as shown in step 77. Simultaneously, the message handler 37 invokes the timer 48 to commence timing the further time period, in the present example 30 seconds, during which time it waits for a reply from Client A.

If the SMSC server 21 is busy, then the host server 13 is notified and continues to poll the SMSC server until it is not busy, as represented by step 79.

Once the SMSC server is not busy, it receives the SMS message packet 73 from the host server and transmits it to Client A as shown by step 81.

If Client A is not ready, then the SMSC server 21 polls Client A until it is ready as shown by step 83, and then sends the SMS message packet 73 to Client A.

On receiving the further text message, Client A notifies Party A and on request, displays the message portion 51 of the further text message on the display of the client to Party A.

In order to respond to the further text message, Party A simply has to invoke the “reply to” facility on Client A, which is standard for SMS messaging systems, and compile another text message in accordance with a second prescribed client protocol simply comprising entering of the party's PIN. Once this is compiled and sent, as shown by step 85, the message packet 87 is automatically created by the messager 47 with the “reply to” address incorporating the pseudo-random number as provided in the further text message received from the host server inserted into the intended recipient's address portion 53.

In the present example, the number “01925381274” will be inserted Into the intended recipient's address portion 53, the number “+631975551234” inserted into the sender's address portion 55 and the number “+639112345678” inserted into the SMSC address portion 57.

The messager 47 may be further prompted by the further text message to cause a series of default characters such as “######” to appear when the PIN is entered so as to provide further security to Client A.

As previously mentioned, the message handler 37 invokes the timer 48 to count down the requisite 30 second time period, which is represented by step 87. If the message handler does not receive a reply from Client A, and importantly does not receive a reply, within this 30 second period, the message handler invokes the abandonor 43 to abandon the operation of the host server in attending to the transaction, as shown at step 89.

If the message handler 37 does receive a reply from Client A within the prescribed 30 second time period, the message handler then invokes a further process to verify the PIN provided in the message portion of the received other text message, as shown at step 91.

In order to verify the PIN, the message handler 37 accesses the client database 45 and compares the received PIN against the PIN that is entered for Client A in the client database. If the PIN Is incorrect, the abandonor 43 Is invoked to abandon the transaction, as shown at step 89.

If the PIN is verified to be correct, the message handler 37 proceeds to check that the “reply to” address has correctly specified the pseudo-randomly generated number that was appended to the access code, as shown at step 93. It should be appreciated that the host server 13 may still receive a reply from Client A by virtue of the correct access code being entered in the “reply to” address, but a different number could be appended to the access code from the randomly generated number selected by the random number generator 46. In such an instance, the message handler 37 is programmed to not accept that a reply has occurred and invoke the abandonor 43 to abandon the transaction as shown by step 89.

Such an arrangement overcomes a problem that would arise if the “reply to” address was kept the same as the host server's address in the originating text message, whereby the address could be spoofed by an unauthorised user of the client device.

In the event of the transaction being abandoned either by virtue of: a response not being received from Client A within the required time, the PIN specified in the response from Client A not being verified as correct, or the “reply to” address not being correctly specified; the abandoner 43 causes the message handler 37 to compile an abandonment text message notifying Client A that the transaction has been abandoned for which ever reason caused the abandonment, as shown at step 95.

After the message handler 37 sends this message to Client A from the host server 13, the transaction process being undertaken by the host server is terminated and no further action is taken as shown at step 97.

If the response from Client A satisfies these three conditions, namely that: the reply is received within 30 seconds, a correct PIN is specified, and the correct “reply to” address is specified; then depending upon the level of security required by the authenticator 39 for the particular type of transaction, one of two things may occur as shown at step 99. If the transaction is just to check a balance of an account, or involves an amount below a prescribed threshold value, or is with a party having a prescribed payment status, or for some other reason is of a type not requiring authentication of the other party (Party B in this example), the authenitcator 39 is programmed to be satisfied that authentication of Party A soley is sufficient to authenticate the transaction. In this event, the authenticator 39 validates the transaction and invokes the transactor 41 to actually effect the transaction as shown at step 101 between the parties using the account facilities 25 established at the relevant banks of the parties.

If on the other hand the transaction requires a higher level of security involving authentication of Party B, for example if payment was being sort by Party A to be made from Party B to itself, or if an amount exceeding a prescribed threshold was involved etc, then a process requiring authentication of Party B would be undertaken before the transaction would be authenticated to proceed.

In such eventuallity, the message handler is invoked to follow a similar authentication process as it pursued with Party A, but this time with the client device 15b (Client B) of Party B. Moreover, it compiles an advisory text message in accordance with a second prescribed server protocol, as shown at step 103. This advisory text message is sent in the form of an SMS message packet 105 to Client B. This second prescribed server protocol involves the message handler 37 entering:
an advice describing the transaction to go in the message portion 51 of the message packet 105;
a request for the PIN of Client B also to go in the message portion 51; and
a prescribed “reply to” address to go in the sender's address portion 55 of the message packet.

In the present example, the advice and PIN request message that is entered reads “Party A wants to send you P500. Would you like to accept it? Reply with your PIN, then “+CURRENT”, “+SAVINGS”, “+PAYSETTER”, or “+REJECT”.”.

The prescribed “reply to” address comprises the access code plus a number of digits that may either be generated using the pseudo-random number generator 46 or be just a standard number, depending upon the level of security required. In the present embodiment, a pseudo-random number Is generated and appended to the access code as shown by step 107. In the present example, the access code is “091” and the pseudo-random number is “63429481”.

Once the message handler 37 has finished compiling the advisory text message, it then sends the advisory SMS message packet 105 to the SMSC server 21 via the communication link 23, as shown by step 109. Simultaneously, the message handier invokes the timer 48, times the further time period of 30 seconds and waits for a reply from Client B.

A similar process flow to that involved with sending the reply SMS message packet 73 to Client A via the SMSC server 21 then ensues with sending the advisory SMS message packet 105 to Client B via the SMSC server. Moreover, the step of checking whether the SMSC server is busy and polling it if it is, is undertaken at step 111. Obviously if polling is required to be performed, the count down time 48 is reset each time to ensure that the further time period only commences from when the SMSC server 21 is able to receive the message packet and transmit it via the GSM mobile telephone network 17 at step 113. Similarly, the SMSC server checks to see if Client B is ready to receive the advisory message packet at step 115, polls it if it is not ready and eventually sends the message when it is ready.

On receiving the advisory text message, Client B notifies Party B and on request, displays the message portion 51 of the advisory text message on the display of the client to Party B.

In order to respond to the advisory text message, Party B simply invokes the “reply to” facility on Client B and compiles a reply text message in accordance with a first prescribed client protocol for Client B. This protocol comprises entering the PIN of Client B for the host server 13 and the identy of the account to which the payment should be mad—either a personal account 33 such as SAVINGS or CURRENT, or the common account 35—or whether the transaction is to be rejected.

Once this is compiled and sent, as shown by step 117, the reply SMS message packet 119 is automatically created by the messager 47 with the “reply to” address incorporating the pseudo-random number as provided in the advisory text message inserted into the intended recipient's address portion 53.

In the present example, the number “019639163429481” is inserted into the intended recipient's address portion 53 (Access code+pseudo-random number), the number “+639175551234” Is inserted into the sender's address portion (Party B's GSM telephone number) and the number “+639112345678” is inserted into the SMSC server address portion 57 (the GSM telephone number of the SMSC server 21).

As shown in FIG. 5B, the message handler 37 undergoes similar processes to those undertaken when receiving the reply SMS message packet 87 from Client A, with respect to receiving the reply SMS message packet 119 from Client B. Moreover, the 30 second time out process for receiving the reply SMS message packet 87 is performed as shown by step 121, followed by verfiying the correct PIN at step 123, and then checking the correct “reply-to” address at step 125, to achieve authentication of Client B by the authenticator 39 and subsequent invoking of the transactor 41, as shown at step 127; or alternatively abandonment of the transaction on failing to achieve authentication, as shown by step 129, whereupon the transaction is terminated.

In the case of the clients being authenticated, the authenticator 39 invokes the transactor 41 to proceed with effecting the actual transaction with the actual bank(s) of the parties as mentioned at step 127.

With respect to perfecting the actual transaction between the two parties after authentication, it should be appreciated that the facility of providing a common account 35 at each bank of a party provides great advantage in being able to expedite a transaction that involves a transfer between two or more banks. Moreover, the transaction can proceed as a transfer between internal accounts from each individual bank's perspective, ie as a transfer between a transacting party's personal account and the common account 35 of the financial service provider at the same bank, and not as an external transfer between the respective parties' personal accounts held at different banks. Thus any party-to-party financial transaction would proceed on the basis of a credit to the financial service provider's common account at the bank of the party making the payment, Party A in the present example, and and a debit to the financial service provider's common account at the bank of the other party receiving the payment, Party B.

Consequently, the transaction can occur immediately in real time, without having to wait for the respective banks of the parties to process an interbank transaction, which normally takes several days.

The transactor 41, in communicating with the bank servers 29 to perfect the transaction in accordance with the prescribed transaction control algorithm after Client A, and Client B where appropriate, has been authenticated, initially provides the bank server 29a associated with the bank of Party A with:
the CAN of Party A,
the nature of the transaction, being a debit from the particular personal account, say account 33a, corresponding to the CAN of Party A, and a credit to the common account 35 of the financial service provider with the same bank, and
the amount of the transaction.

Accordingly, the transactor 41 accesses the client database 45 to retrieve the CAN of Party A and any other information stored therein to enable the transaction to proceed. The bank server 29a then checks the balance of the account 33a corresponding to the CAN with the specified amount of the transaction, and if sufficient funds are available in the account to enable the transaction to proceed, effects the transfer to the common account 35.

The bank server 29a then communicates with the host server 13 affirming that the first stage of the transaction with the bank of Party A has been effected.

If, on the other hand, the bank server 29a establishes that there are insufficient funds in the account 33a to enable the transaction to proceed, the bank server communicates with the host server 13 informing it of such, whereupon the transactor 41 invokes the abandoner 43 to abandon and terminate the transaction in the manner previously described.

After the bank server 29a affirms that the first stage of the transaction has been effected, the transactor 41 then communicates with the bank server 29b associated with the bank of Party B and provides the bank server 29b with:
the CAN of Party B,
the nature of the transaction, being a credit to the particular personal account, say account 33b, corresponding to the CAN of Party B, and a debit from the common account 35 of the financial service provider with the same bank, and
the amount of the transaction.

On receipt of this information, the bank server 29b proceeds with effecting the transfer between the relevant bank accounts.

The bank server 29a then communicates with the host server 13 affirming that the second stage of the transaction with the bank of Party B has been effected.

On receipt of this information, the transactor 41 then invokes the message handler 37 to compile a confirmation text message to both Clients A and B confirming that the transaction has been effected in accordance with a third server protocol modified to suit each client, as represented by step 131. This confirmation text message is sent in the form of confirmation SMS message packets, one 133a to Client A and another 133b to Client B, as shown in FIG. 4F.

The third server protocol simply involves the message handler 37 entering a confirmation of the effected transaction relative to the particular client in the message portions 51 of the message packets 133a and 133b.

In the present example, the confirmation message that is entered reads for Client A: “P500 has been withdrawn from your savings account.”; and for Client B: “P500 has been transferred to your savings account.”.

The remaining portions of the message packets 133 are entered with the appropriate address information for sending the same to the appropriate client, as shown.

With respect to registering a user with the host server 13 for the first time, an important aspect of the present embodiment is linking the GSM telephone number of a party wishing to utilise the services of the financial service provider with the CAN for the account facilities 33 of the party in real time. Once linked, financial transactions can be undertaken directly and simply between the client of ne party registered with the host server and the client of another party registered with the host server using only the mobile telephone numbers of either party, without the one party having to enter their own CAN number nor the CAN of the other party. In this manner, the CAN's of either party don't need to be remembered by either party, just the mobile telephone numbers, and these are normally conveniently stored within the client device of a party for automatic dialling purposes when required.

The linking between the GSM mobile telephone number and the CAN of a party can be achieved a number of different ways.

One way is via the particular bank or financial institution of the party wishing to utilise the services of the financial service provider with either the party's personal bank accounting facilities or an accounting facility provided by the bank such as an account allocated by the bank to a debit card or pre-paid cash card. In such an arrangement, the party makes application to the bank to utilise the services of the financial service provider for the particular accounting facility desired to be accessed in this manner and provides the bank with details of their GSM mobile telephone number. Depending upon whether the party is an existing customer with the bank, the bank may provide the party with the option to utilise their existing PIN for their personal bank accounting-facilities, or obtaining a separate PIN which is allocated to the party by the bank, which would be the case in accessing an accounting facility provided by the bank.

The bank then proceeds with processing the details of the party with the financial service provider, providing the financial service provider with the CAN of the party, the relevant bank account number(s), the GSM mobile telephone number of the party to be linked to the bank account number(s), and the PIN of the party, being either the party's existing PIN, or that which is allocated to the party by the bank. The financial service provider then enters the relevant GSM mobile telephone number as the CIN of the party, the allocated PIN as the PIN of the party, the CAN of the party and the relevant bank account number(s) associated therewith, into the client database 45 of the host server 13 to effect the registration.

The party is then notified of its registration and that the facility is available for use. If a new PIN is allocated to the party, then this is forwarded to the party, together with or separately of the notification and either together with or separately of the debit or cash card, if such is applied for. Once the party receives notification together with the PIN, if requested, the party is free to perform transactions directly with the host server 13 via their GSM mobile telephone number.

Another way of achieving the linking, is via the party and the host server 13 itself. In this arrangement, the party wishing to utilise the services of the financial service provider with either the party's personal bank accounting facilities or an accounting facility provided by the bank, applies to the bank to utilise the service. As the party and the host server 13 will be doing the linking, it is not necessary to provide the bank with their GSM mobile telephone number. As before, the bank may provide the party with the option to use their existing PIN for accessing their personal bank accounting facilities or obtain a separate PIN.

The bank will process the details of the party and provide the financial service provider with the CAN of the party, the relevant bank account number(s) to be accessed and the relevant PIN for the party. The financial service provider then enters this information into the client database 45 of the host server 13, ready for registration.

The party is then notified that the system is available for registration and if the party nominated for a separate PIN, is supplied with the PIN either together with or separately of the debit or cash card if the latter was requested.

The party is also provided with instructions on how to complete registration via the host server 13.

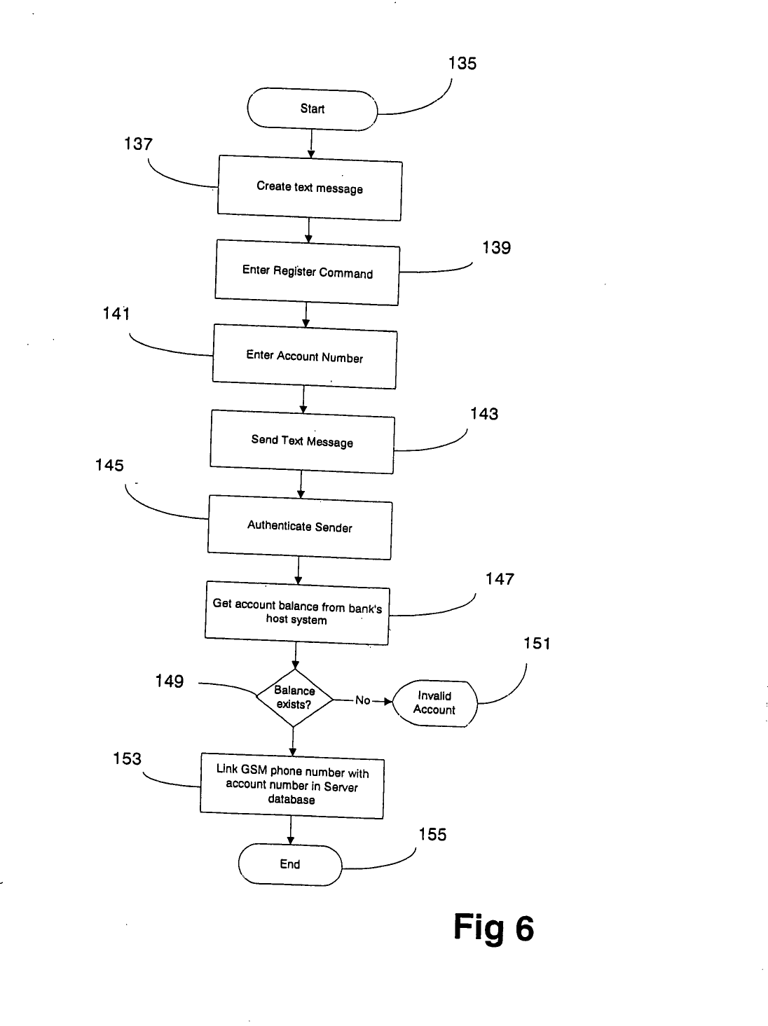

The process followed in order to complete registration is shown in FIG. 6 and will now be described in more detail.

As represented in FIG. 6, the registration process commences at step 135, where the party requiring to complete the registration process with the host server 13 compiles a registration text message with their GSM mobile telephone 15 using the messager 47 thereof in accordance with a prescribed registration protocol, the commencement of the creation of this message 15 is generally represented by step 137. The registration text messge is sent in the form of a registration SMS message packet, whereby the registration protocol for creating this message packet involves the party entering:
a registration command signified by a prescribed mnemonic that represents to the message handler 37 that the received message packet contains information for registering the party as a client, shown by step 139,
a bank account number including the bank identificaton code being the personal bank account of the party to be used for financial transactions with the host server, shown by step 141, and
the access number of the host server and a prescribed initiating address number appended thereto.

The first two entries mentioned above are made so as to go in the message portion 51 of the registration SMS message packet, and the last entry is made to go into the intended recipient's address portion 53 of the packet.

On completing compiling the registration text message, it is then sent by the client to the SMSC server 21, which then directs it to the host server 13 via the communication link 23 in the manner as previously described, all of which is represented by step 143.

On receipt of the registration message packet by the host server 13 and decoding by the message handler 37, the message handler undertakes the authentication process as previously described in relation to effecting a transaction between two registered parties, using their PIN, as represented by step 145.

After the authenticator 39 authenticates the client, the registrar 38 is then invoked to undertake a checking process of the specific personal bank account 33 of the party associated with the client with the banking server 29 associated with the accounting facilities of the party. This checking process involves requesting the banking server 29 for the current balance of the personal bank account 33 of the party in question to verify that the bank account actually exists, as represented by step 147.

On receipt of a reply from the banking server 29, the registrar 38 is able to ascertain whether a balance actually exists as represented by step 149, and if not, invokes the abandonor 43 to abandon the registration process. In this event, the abandonor 43 causes the message handler 37 to compile an abandonment text message that is returned as an abandonment SMS message packet to the client containing a message that the bank account details supplied were invalid. The abandonor 43 then terminates the registration process resulting in the host server 13 taking no further action in the matter, all of which is represented by step 151.

On the other hand, if a balance is returned, the registrar 38 verifies that the bank account is valid. It then proceeds to map the GSM telephone number for the client provided in the registration SMS message packet to the bank account number, and stores the GSM telephone number as the CIN in the client database 45, along with the CAN, personal bank account numbers and PIN of the party, all of which have been previously stored in the client database 45. The registrar 38 then causes the message handler 37 to compile a registration confirmation text message as an SMS message packet, confirming that the registration process has been successfully completed and that the host server is ready to undertake transactions for the client, all of which is represented by step 153.

The registration process is then completed as represented by step 155.

Although the present embodiment has been specifically described with regard to a specific example of a financial transaction involving payment from the client of an initiating party to the client of a responding party, transactions involving the initiating party obtaining a payment from a responding party follow a similar course, albeit for the transaction logically following a different direction of funds transferral between the parties. Similarly, a merely seeking an account balance can be easily accommodated following a similar course of authentication, but resulting in the banking server supplying the current balance details of the account, similar to the process undertaken in the registration procedure, although the amount of the current balance would actually be returned to the client of the party.

In the present embodiment, the financial service provider is contractually established as a “super user” with respect to the banks that are associated with system. Thus the financial service provider has permission to effect transfers between accounts of bank customers registered as clients with the host server 13 with reduced authentication requirements, upon such customers achieving authentication with the host server. In this regard, the host server is permitted to access the personal accounts of a party to perfect a financial transaction with just the CAN of the party, without providing any PIN of the client, if it exists.

It should be appreciated that in situations where the financial service provider is still required to provide a level of authentication requiring the provision of a client PIN to access a personal account of a party with a bank, further embodiments of the invention are provided to facilitate same. In such embodiments, the provision of a PIN for the bank account of a party can be relatively easily accommodated by having the registration procedure of the party as a client with the host server 13 include the requirement of the client providing a PIN for the particular bank account that the party wishes to access via the host server. This bank account PIN would then be stored in the client database 45 together with the CAN, CIN and PIN for host server authentication. Indeed, in other embodiments of the invention, the bank account PIN and the host server PIN may in fact be identical.

As indicated above, there are many variations that may be apparent to the system and method in order to accommodate particular circumstances not specifically described in the preceding embodiment(s) that nonetheless fall within the spirit and scope of the present invention. Therefore, it should be appreciated that the scope of the present invention is not limited to the scope of the particular embodiment herein described.

1. A method for performing a financial transaction for a party having an electronic messaging facility, the party having an electronic messaging address and a banking account number for a banking account with a financial institution, whereby a financial transaction may be performed with the banking account, and the financial institution having a banking server for effecting a financial transaction with the banking account, the method comprising:—
serving an electronic message from a client of the party, the electronic message:
(i) being sent to a predetermined electronic messaging address for performing a particular type of financial transaction;
(ii) being prepared in accordance with a first prescribed protocol; and
(iii) requesting that the particular type of financial transaction be performed; and
requesting the banking server of the financial institution of the party to effect the financial transaction in accordance with the first prescribed protocol of the electronic message.

2. A method as claimed in claim 1, wherein the server includes serving an electronic message to the client of the party in response to serving said electronic message from the client of the party for controlling the progress of the financial transaction.

3. A method as claimed in claim 1 or 2, including linking the electronic messaging address to the banking account of the party.

4. A method as claimed in any one of claims 1 to 3, wherein the server includes authenticating the identity of the party before proceeding with requesting the banking server to effect the transaction.

5. A method as claimed in claim 4, wherein the authenticating includes requesting a personal identification number (PIN) to be provided by the party in a further electronic message prepared in accordance with a second prescribed protocol, and verifying that the PIN provided in the further electronic message is correct.

6. A method as claimed in claim 5, wherein the authenticating includes timing out a prescribed time period after requesting the PIN from the party and abandoning the financial transaction if the further electronic message is not provided by the party within said prescribed time period.

7. A method as claimed in any one of claims 4 to 6, wherein the authenticating includes supplying a different electronic messaging address to the party from the predetermined electronic messaging address, for the party to reply to in order to progress the financial transaction.

8. A method as claimed in claim 7, including pseudo-randomly generating part of the different electronic messaging address to ensure that it is different and not derivable from the predetermined electronic messaging address.

9. A method as claimed in any one of the preceding claims, wherein the particular type of financial transaction involves a financial transaction between two said parties each having electronic messaging facilities, whereby:
(iii) the electronic message is served from a client of one party and includes requesting that the particular type of financial transaction be performed with the other party; and
(iv) the banking server of the financial institution of each party is requested to effect the financial transaction relative to the particular party in accordance with the first prescribed protocol of the electronic message.

10. A method as claimed in claim 9, wherein the electronic message includes the electronic messaging address of the one party and either the electronic messaging address or the banking account number of the other party.

11. A system for performing a financial transaction for a party having an electronic messaging facility, the party having an electronic messaging address and a banking account number for a banking account with a financial institution, whereby a financial transaction may be performed with the banking account, and the financial institution having a banking server for effecting a financial transaction with the banking account, the system comprising:—
a financial service provider server for serving an electronic message from a client of the party, the electronic message being prepared in accordance with a first prescribed protocol and including:
(i) a predetermined electronic messaging address dedicated to the performance of a particular type of financial transaction; and
(ii) a request that the particular type of financial transaction be performed;
wherein the financial service provider server includes message handling means to receive and decode said electronic message, and transacting means to request the banking server of the financial institution of the party to effect the financial transaction in accordance with the first prescribed protocol of the electronic message on the financial service provider server receiving said electronic message.

12. A system as claimed in claim 11, wherein said message handling means is adapted to serve an electronic message to the client of the party in response to serving said electronic message from the client of the party for progressing the financial transaction.

13. A system as claimed in claim 11 or 12, wherein said financial service provider server includes a database that links said electronic messaging address to the banking account of the party.

14. A system as claimed in any one of claims 11 to 13, wherein said financial service provider server includes authenticating means to authenticate the identity of the party before invoking said transacting means.

15. A system as claimed in claim 14, wherein said message handling means is adapted to request a PIN from the party in a further electronic message prepared in accordance with a second prescribed protocol, and the authenticating means includes verifying means to verify that the PIN provided in the further electronic message is correct.

16. A system as claimed in claim 15, wherein said authenticating means includes timing means to time out a prescribed time period after requesting the PIN from the party and said financial service provider server includes abandoning means to abandon the financial transaction if said further electronic message is not provided by the party within said prescribed time period.

17. A system as claimed in any one of claims 14 to 16, wherein the authenticating means includes supplying a different electronic messaging address to the party from the predetermined electronic messaging address for the party to reply to in order to progress the financial transaction.

18. A system as claimed in claim 17, wherein the message handling means includes a pseudo-random number generating means to pseudo-randomly generate part of the different electronic messaging address to ensure that it is different and not derivable from the predetermined electronic messaging address.

19. A system as claimed in any one of claims 11 to 18, wherein the particular type of financial transaction involves a financial transaction between two said parties each having electronic messaging facilities, whereby:
(i) said electronic message is served by said financial service provider server from a client of one party at an electronic messaging address dedicated to the performance of a financial transaction between the two parties and includes a request that the particular type of financial transaction be performed with the other party; and
(ii) the banking server of the financial institution of each party is requested by said financial service provider server to effect the particular financial transaction relative to the particular party in accordance with the first prescribed protocol of said electronic message.

20. A system as claimed in claim 19, wherein said electronic message includes the electronic messaging address of the one party and either the electronic messaging address or the banking account number of the other party.

21. A method for performing financial transactions between two parties functioning as clients to a financial service provider server for controlling the transaction, the clients and server being interconnected via a communication network, at least one of the clients being a wireless device, and said financial service provider server being electronically connected to an account facility for each client, each account facility having a personal account for the client identified by an account number, and a wireless communication server for handling messages sent to or received from said wireless device using a wireless identifying number for the wireless device, the method comprising:—
ascribing a client identifying number to each of the clients of the financial service provider server to uniquely identify each client to the financial service provider server;
ascribing an access code to the financial service provider server to uniquely identify the financial service provider server to the wireless communication server and the nature of the transaction to be performed;
registering the account number of each client with the financial service provider server to enable the financial service provider to access the personal account of the party associated with the client;
registering a personal identification number (PIN) for each client;
a sender client compiling and sending a text message to the financial service provider server in accordance with a first prescribed client protocol comprising:
the amount to be transacted,
the address of the other party to the transaction comprising: (i) the access code identifying the financial service provider server and the nature of the transaction, and (ii) the client identifying number of the other client, and
the client identifying number of the client sending the message;
the financial service provider server on receipt of said text message compiling and sending back a further text message to the sender client in accordance with a first prescribed server protocol comprising:
a confirmation of the transaction to be performed,
a request for the PIN of the client, and
a “reply to” address that is different to the previous address of the receiver;
the sender client on receipt of said further text message compiling and sending back another text message to the “reply to” address with a second prescribed client protocol comprising the PIN thereof;
the financial service provider server waiting a prescribed time for receipt of said other text message and if received within said prescribed time, verifying the PIN and if correct, compiling and sending an advisory text message to the other client in accordance with a second prescribed server protocol that includes an advice describing the transaction; and
on authenticating the transaction, the financial service provider server effecting the transaction between the account facilities of the parties to the transaction to which the financial service provider server is connected;
wherein if either said prescribed time elapses without receipt of said other text message or if the PIN is not verified to be correct by the financial service provider server, the transaction is abandoned by the financial service provider server.

22. A method as claimed in claim 21, including generating the “reply to” address in accordance with the first prescribed server protocol to include the access code and a pseudo-randomly generated number.

23. A method as claimed In claim 21 or 22, including the financial service provider server generating a prescribed “reply to” address comprising the access code of the financial service provider server to be included in the second prescribed server protocol.

24. A method as claimed in claim 23, wherein the second prescribed server protocol includes: the financial service provider server also including a request for the PIN of the other client in the advisory text message and making the prescribed “reply to” address different from any previous address identifying the financial service provider server; and
the method includes:
the other client compiling and sending back a reply text message to the prescribed “reply to” address with the PIN thereof on receipt of the advisory text message; and
the financial service provider server waiting a prescribed time for receipt of said reply text message and if received within said prescribed time, verifying the PIN and if correct, authenticating the transaction.

25. A method as claimed in claim 23 or 24, including generating the prescribed “reply to” address so that it includes the access code and a pseudo-randomly generated number.

26. A system for performing financial transactions between two parties comprising:—
a financial service provider server for controlling a financial transaction between the parties;
each party having:
(i) an account facility that includes a personal account for the party identified by an account number registered with said financial service provider server,
(ii) a client for connection to said financial service provider server via a communication network, whereby at least one of the clients is a wireless device,
(iii) a client identifying number to uniquely identify each client to the financial service provider server, whereby the client identifying number for the client that is a wireless device corresponds to the wireless identifying number thereof, and
(iv) a PIN registered with said financial service provider server;
said financial service provider server being electronically connected to:
(i) each account facility and being able to identify and access same by said account number on registration of same with said financial service provider server, and
(ii) a wireless communication server for handling messages sent to or received from said wireless device using a wireless identifying number for the wireless device;
a said client having messaging means for compiling and sending text messages to said financial service provider server in accordance with:
(i) a first prescribed client protocol comprising:
the amount to be transacted,
the address of the other party to the transaction comprising: an access code to uniquely identify the financial service provider to the wireless communication server and the nature of the transaction to be performed, and (ii) the client identifying number of the other client, and
the client identifying number of the client sending the message; and
(ii) a second prescribed client protocol comprising the PIN thereof; and
the financial service provider server having message handling means, authenticating means, transacting means and transaction abandoning means;
wherein:
(a) said message handling means is designed to:
(i) receive a said text message and compile and send back a further text message to the sender client in reply thereto in accordance with a first prescribed server protocol therefor comprising:
a confirmation of the transaction to be performed,
a request for the PIN of the client, and
a “reply to” address that is different to the previous address of the receiver; and
(ii) wait a prescribed time for receipt of another text message from the sender client in accordance with a second prescribed client protocol comprising the PIN of the sender client, and if said other text message is received within said prescribed time, verify the PIN and if correct, compile and send an advisory text message to the other client in accordance with a second prescribed server protocol comprising an advice describing the transaction;
(b) said authenticating means is designed to authenticate the transaction on said message handling means establishing a prescribed level of security of the identity of the parties to the transaction;
(c) said transacting means effecting a transaction in accordance with said text message between the parties in response to said authenticating means authenticating said transaction; and
(d) said transaction abandoning means abandoning said transaction if either said prescribed time elapses without receipt of said other text message or if the PIN is not verified to be correct by the message handling means.

27. A system as claimed in claim 26, wherein the message handling means includes a pseudo-random number generating means to pseudo-randomly generate a number, and said message handling means generates the “reply to” address in accordance with the first prescribed server protocol for said further text message, so as to comprise the access code and the pseudo-randomly generated number.

28. A system as claimed in claim 26 or 27, wherein the message handling means generates a prescribed “reply to” address in accordance with the second prescribed server protocol for said advisory text message, comprising the access code of the financial service provider.

29. A system as claimed in any one of claims 26 to 28, wherein the advisory text message compiled in accordance with said second prescribed server protocol includes a request for the PIN of the other client and a prescribed “reply to” address that is different from any previous address identifying the financial service provider server.

30. A system as claimed in claim 29, wherein said message handling means is also designed to wait a further prescribed time for receipt of a reply text message from the other client in accordance with a first prescribed client protocol for the other client comprising the PIN of the other client, and if received within said further prescribed time period, verify the PIN.

31. A system as claimed in claim 29 or 30, wherein the prescribed “reply to” address is generated so that it includes the access code and a further pseudo-randomly generated number from said pseudo-random number generating means.

32. A system as claimed in any one of claims 26 to 31, wherein said authenticating means authenticates the transaction if said message handling means verifies that the PIN of the other client received in said reply text message is correct.

33. A method substantially as herein described with respect to the accompanying drawings where appropriate.

34. A system substantially as described herein with respect to the accompanying drawings where appropriate.
